(19) United States
(12) Patent Application Publication
(10) Pub. No.: US 2018/0369853 A1
(43) Pub. Date: Dec. 27, 2018

(54) AEROSOL APPARATUS WITH IMPROVED SEPARABLE MEMBRANE

(71) Applicant: TTP Plc, Royston, Hertfordshire (GB)

(72) Inventor: David POOLEY, Royston, Hertfordshire (GB)

(21) Appl. No.: 15/741,420

(22) PCT Filed: Jul. 1, 2016
(86) PCT No.: PCT/GB2016/052002

§ 371 Date: Jan. 2, 2018

(30) Foreign Application Priority Data
Jul. 3, 2015 (GB) 1511676.7

(51) Int. Cl. B05B 17/00; B05B 17/06; H01F 7/02

(52) U.S. Cl. CPC B05B 17/0646; H01F 7/0252; B05B 17/0653

(57) ABSTRACT

A liquid droplet production apparatus comprising a separable perforate membrane (44), a means for supplying liquid to one side of the membrane, an actuator (41) for vibrating a membrane, so that the vibration causes liquid droplets to be ejected from the other side of the membrane, in which a magnetic force is used to connect the actuator to the membrane so that the vibration can be transmitted, wherein the magnetic force is generated by one or more arrays of magnets (43), eventually on a substrate (42), each array containing either a plurality of magnets or at least one magnet having a multiple pole configuration.

### RELATED APPLICATIONS

The present application is a national stage application under 35 U.S.C. § 371 of International Application No. PCT/GB2016/052002, filed 1 Jul. 2016, which claims priority to Great Britain Patent Application No. 1511676.7, filed 3 Jul. 2015. The above referenced applications are hereby incorporated by reference into the present application in their entirety.

This invention relates to a liquid droplet production apparatus, especially to electronic spray devices in which a vibrating perforate membrane is used to generate liquid droplets; in particular, to how such devices can be made more useful by enabling the separation of the vibrating membrane from its driver element.

According to a first aspect of the invention, there is provided a liquid droplet production apparatus comprising: a perforate membrane; a means for supplying liquid to one side of the membrane; an actuator for vibrating a membrane, so that the vibration causes liquid droplets to be ejected from the other side of the membrane; in which a magnetic force is used to connect the actuator to the membrane so that the vibration can be transmitted, wherein the magnetic force is generated by one or more arrays of magnets, each array containing either a plurality of magnets or at least one magnet having a multiple pole configuration.

### INTRODUCTION & PRIOR ART ON SEPARABLE MEMBRANE TECHNOLOGY

Electronic nebulisers that use ultrasonic vibration to generate liquid droplets are well known in the art and have found use in a wide range of fields including medical drug delivery and the treatment of air (for example fragrance delivery and humidification). A subset of such devices in widespread use (commonly referred to as ‘pond misters’) use a vibrating surface covered by liquid to cause droplets to be generated though the break-up of standing waves on the liquid free surface (U.S. Pat. No. 3,812,854 being an example). This break-up leads to droplets with a wide range of sizes being produced and shaping of the liquid container above the level of the liquid is used to limit the size range of droplets that escape and are delivered. With a wide range of droplets being contained and returned to the bulk liquid, such devices have low efficiency resulting in high power consumption. The efficiency of such devices can be improved by constraining the free surface of the liquid with a perforate membrane (U.S. Pat. No. 4,533,082 for example). This membrane may have just a single nozzle (for dispensing or printing applications for example in which individual drops may be dispensed on demand) or may have many thousand nozzles (for nebuliser applications for example). Relatively monodispersed droplets are produced when such perforate membranes are used in which the droplet diameter is related to the size of the openings, or nozzles, in the perforate membrane. Such devices still suffer multiple disadvantages: In particular, the vibrating surface needs to be mounted close to the membrane, but not touching, for effective droplet generation and not all liquid in the container can be delivered (as the liquid is required to transmit the pressure waves to the perforate membrane). A preferred embodiment of such devices is therefore one in which the perforate membrane itself is vibrated by the driver element (commonly called the actuator) with examples including U.S. Pat. No. 4,533,082 and EP 0431992. This enables the delivery of relatively well monodispersed droplets without requiring the pressure waves to be transmitted through a liquid layer further increasing efficiency and enabling a wider range of embodiments. A preferred embodiment of such a device such as described in U.S. Pat. No. 5,518,179 uses a bending mode actuator to deliver the vibrational energy to the membrane as this enables the use of thin low cost actuators and further increases efficiency.

Often it is desirable to use a master-cartridge model in which a master unit can spray liquid contained in a replaceable cartridge. Preferably, all liquid contacting components reside on the cartridge and as many non-liquid contacting components as possible reside on the master. This minimises the cost of the cartridge whilst avoiding liquid cross-contamination between cartridges and liquid contamination of the master. Examples of fields where such an approach finds use are the medical field and the consumer fragrance field. In the medical field dose sterility can be critical and this can be achieved by containing each dose in its own cartridge (or capsule). Also in the medical field the same master device may be designed to be used with more than one patient and cross-contamination should be avoided. In the fragrance field, each cartridge may contain a different fragrance and again cross-contamination should be avoided. Other fields in which similar requirements are met will be obvious to someone skilled in the art.

One approach to avoid cross contamination is to place the perforate membrane and actuator into the cartridge component with the electronics and power source in the master. This limits the required connection between the two components to electrical but, with the actuator in the cartridge, leaves a relatively high cost component in the cartridge. Further, and more importantly for medical applications where each cartridge contains a single dose, the cartridge size may be relatively large compared to the amount of liquid it contains. There is therefore a need to move the actuator out of the cartridge component leaving just the liquid contacting perforate membrane as this approach can reduce both cartridge cost and size.

The requirement to avoid cross contamination is known in the art and, for relatively inefficient applications where low power consumption is not crucial, solutions have been proposed. U.S. Pat. No. 3,561,444 teaches, for a pond-mister style device, using a liquid that is not dispensed to provide the connection between the vibration element in the master and the surface to be vibrated in the cartridge. U.S. Pat. No. 4,702,418, WO 2006/006963, WO 2009/150619, WO 2010/026532 and WO 2009/136304 teach various means of connecting the vibration force to a surface in the cartridge that is situated in close proximity to a perforate membrane with the vibration then transmitted through the liquid to be sprayed. EP 1,475,108 and U.S. Pat. No. 5,838,350 teach of a piezoceramic component directly to a perforate membrane but do not teach how this can be done in an efficient manner or without the connection approach resulting in excessive energy absorption. The Büchi B-90 Nano Spray Drier enables the perforate membrane to be replaced by requiring the user to screw the membrane onto the actuator using a custom nut to a specified torque level. Whilst this is suitable for a laboratory instrument the replacement process is hard to automate in a compact device it would not be acceptable for a device that is designed to be operated by a consumer for example.

Efficient connection of energy is even more critical for low power devices and in particular for devices where the actuator operates in bending mode as in U.S. Pat. No. 5,518,179. Further, efficient connection of energy through a bending interface is significantly more challenging than efficient connection of energy through a translating interface. This is because a torque in addition to a normal force must be transmitted and also because any structures that result in the device becoming thicker (a screw thread for example) reduce vibration.

In summary, there is a requirement for a means to enable vibration to be effectively transmitted from an actuator to a perforate membrane in which the perforate membrane can be easily removed and replaced by a non-skilled consumer or automatically within a compact device. Such transmission would ideally not absorb excessive vibration energy. Such transmission would ideally not reduce the vibration amplitude of the perforate membrane. These preferable requirements are especially challenging with bending-mode actuator devices as they are more easily damped.

A magnetically attached membrane is disclosed in WO2012/156724. This uses a single magnetic circuit, created by a magnet or pair of magnets, to create an attractive force between an actuator and a separable perforate membrane.

The present invention relates to ways of providing an attachment force that can be stronger than can be achieved with a single magnet. In addition to this, it can be extended across very large actuators. Further advantages, such as improved manufacturability will also become apparent during the detailed description of the invention.

Therefore, according to a first aspect of the invention, there is provided a liquid droplet production apparatus comprising: a perforate membrane; a means for supplying liquid to one side of the membrane; an actuator for vibrating a membrane, so that the vibration causes liquid droplets to be ejected from the other side of the membrane; in which a magnetic force is used to connect the actuator to the membrane so that the vibration can be transmitted, wherein the magnetic force is generated by one or more arrays of magnets, each array containing either a plurality of magnets or at least one magnet having a multiple pole configuration.

A plurality of arrays may be provided. Alternatively only a single array may be used.

Two arrays may be provided on opposing sides of a perforate portion of the membrane.

Opposing arrays of magnets may be aligned such that directly opposing individual magnets have the same plurality alignment.

If a single array is provided, the single array may be arranged in a circular configuration surrounding perforations in the membrane.

Adjacent magnets in an array of magnets preferably have opposing polarity.

Adjacent magnets in an array of magnets may have a polarity which is offset by 90°.

The magnets in an array of magnets may be arranged in a Halbach array.

The membrane is provided with a thinner section in which the perforations may be provided and a thicker section for attachment to the actuator.

The transition from the thinner section to the thicker section may be a step change or may be gradual.

The transition from the thinner section to the thicker section may be by way of a chamfer, a tapered section, or a curved section.

The transition from the thinner section to the thicker section may be at a constant angle.

Generally Applicable Actuator Design and Mounting

This invention is applicable to a wide range of actuator types but is of particular benefit to actuators that use a piezoelectric, electrostrictive or magnetostrictive material (i.e. a material that changes shape in response to an applied electric or magnetic field, henceforth referred to as the active component) in combination with a metal connection or support material (henceforth referred to as the passive component). Examples of such actuators include longitudinal actuators which drive the perforate membrane to vibrate in a direction generally parallel to the expansion and contraction direction of the active component, breathing mode actuators which drive the perforate membrane to vibrate in a direction generally normal to the expansion and contraction direction of the active component and bending mode actuators of the type described earlier and in more detail in U.S. Pat. No. 5,518,179, incorporated herein for reference, to which this invention is particularly applicable. Whilst for some actuators the passive layer does not itself deform and merely acts as a support component, for most actuator designs the passive layer itself expands, contracts, bends or deforms elastically in response to the deformation of the active layer. For example, for a longitudinal actuator the passive component can be used to amplify the strain rate of the active component and, for a bending mode actuator consisting of a unimorph, the passive component's characteristics heavily influence the actuator performance. For such actuators the passive layer material and design, herein referred to as a “deforming passive component”, is integral to the actuator performance and modifying it or adding to its mass will impact the device performance.

For all such actuators a range of factors impact their performance. By performance, we mean their ability to cause the membrane to produce droplets whilst maximising the efficiency, minimising the size and minimising the cost of the overall system. Efficiency is here defined as the ideal energy required to produce the droplets divided by the energy into the system.

In relation to the actuator, particular features that improve performance are reducing actuator mass, reducing internal energy dissipation and reducing energy transmitted to components other than the perforate membrane as described in the following paragraphs:

Reducing actuator mass in general increases performance. This is because any mass needs to be accelerated requiring a force to be applied and increasing the stored energy. For a given quality factor (Q-factor), this leads to additional energy dissipation per vibration cycle. Other disadvantages of increasing actuator mass are an increase in actuator starting and stopping time and either increased complexity, increased cost or reduced efficiency of any drive circuitry, or a combination thereof.

Reducing internal energy absorption of the actuator (i.e. increasing its Q-factor) is important as this energy is dissipated as heat rather than being delivered to the membrane. Deformation of both the active and passive components of the actuator leads to thermal heating as does deformation of any bonding materials. For example, for a bending mode actuator the active and passive components are usually bonded together using an adhesive. Keeping this adhesive layer thin and rigid helps to avoid it absorbing excessive energy.

Reducing energy transmission from the actuator to parts other than the perforate membrane improves performance. This includes the liquid to be delivered as droplets (except in the vicinity of the membrane perforations). In general this can be accomplished by minimising the vibrational amplitude of the actuator (whilst maximising the vibrational amplitude of the membrane). Further, actuators usually need to be mounted to a support structure in order to operate as part of a device and for liquid to be reliably delivered to the perforate membrane. The design and implementation of this mounting can have a significant impact on the actuator performance and the amount of energy transmitted to the perforate membrane. A range of support structures are known in the art for different actuator types (long thin fingers and soft support rings being two such approaches) but in general they try to reduce the transmission of vibrational energy from the actuator to the mount. This can be more easily achieved when the mount does not need to support any large reaction forces that result from forces being applied to the actuator or perforate membrane elsewhere.

Generally Applicable Membrane Design and Actuator Attachment

To transmit energy efficiently from the actuator to the membrane requires careful design of the two components and their interaction. Aside from ensuring the components vibrate at the appropriate frequency and with the appropriate mode shape, a range of generally applicable features are required to deliver maximum membrane velocity for minimum energy consumption. This list of features is similar to what makes a good actuator but with some differences:

Firstly, the mass of the membrane should preferably be minimised especially any mass that does not stiffen the membrane. Minimising its mass reduces the force that must be supplied to it by the actuator reducing losses in that component. Any mass increases increase the required force that needs to be supplied requiring a larger, less efficient actuator.

Secondly, unless the membrane is separately supported (leading to reduced efficiency), the interface between the actuator and the membrane needs to transmit a periodic force oscillating about a mean of zero if gravity is neglected (i.e. the interface must support any instantaneous forces being applied in more than one direction). This may be push/pull, clockwise/anticlockwise torque, or similar.

Thirdly the energy absorbed in the interface between the actuator and the membrane should preferably be minimised. For devices which do not require the separation of the perforate membrane this can be achieved by several methods well known in the art. These include adhesive bonding, welding, brazing and soldering amongst others. All such means add minimal, if any, mass to the device, generally absorb little energy and do not reduce the amplitude of vibrations. They achieve these features by creating a very thin rigid bond directly between the two components. Bolting, clamping or screwing together the components is also used but, as previously discussed, this increases mass and can also impact the vibrational characteristics of the device.

Finally, energy transmitted to the liquid that does not go into the formation of droplets should preferably be minimised. This can be achieved by minimising any area of the membrane that is not perforate (i.e. by minimising areas of vibration that are liquid contacting but are not delivering droplets). Energy transmission to the liquid can also be reduced by using soft wicks or other similar means to deliver liquid rather than contacting the membrane with bulk liquid.

To summarise, any separable membrane design would ideally allow efficient transmission of energy from the actuator to the membrane in the form of an oscillating force about a mean of zero without absorbing energy. It would ideally minimise any mass increase of both the actuator and the membrane. It would ideally minimise any increased damping in the actuator. It would ideally minimise the energy transmitted by the actuator to elements other than the membrane (e.g. mount). It would ideally avoid transmitting energy to the liquid to be delivered.

### PREFERRED EMBODIMENTS

Magnetic connection between the actuator and membrane has the ability to meet all of these preferred requirements. Various embodiments are now described with reference to the following figures:

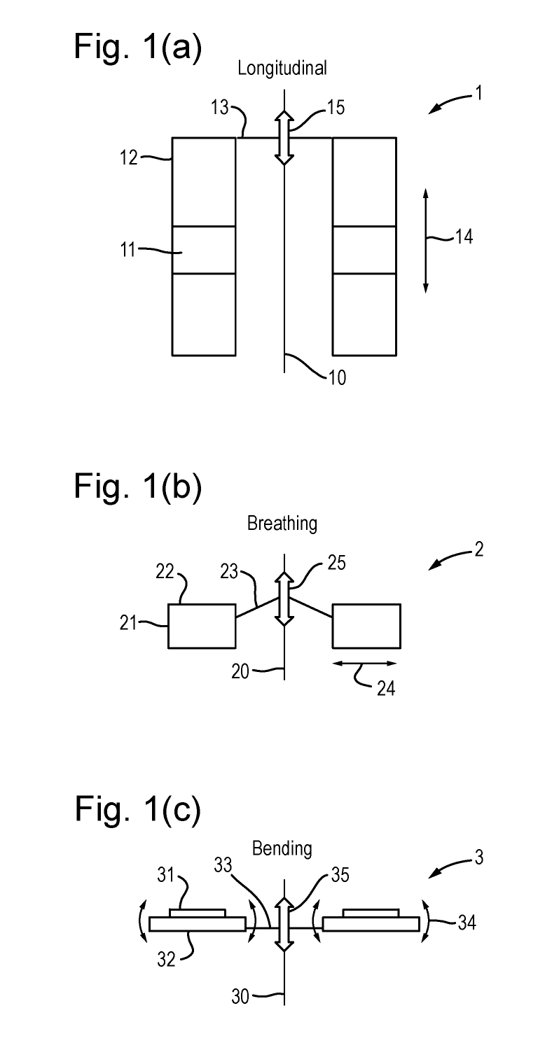

FIGS. 1(a)-1(c) summarise a range of actuator types and their interface to the perforate membrane for current, non-separable constructions.

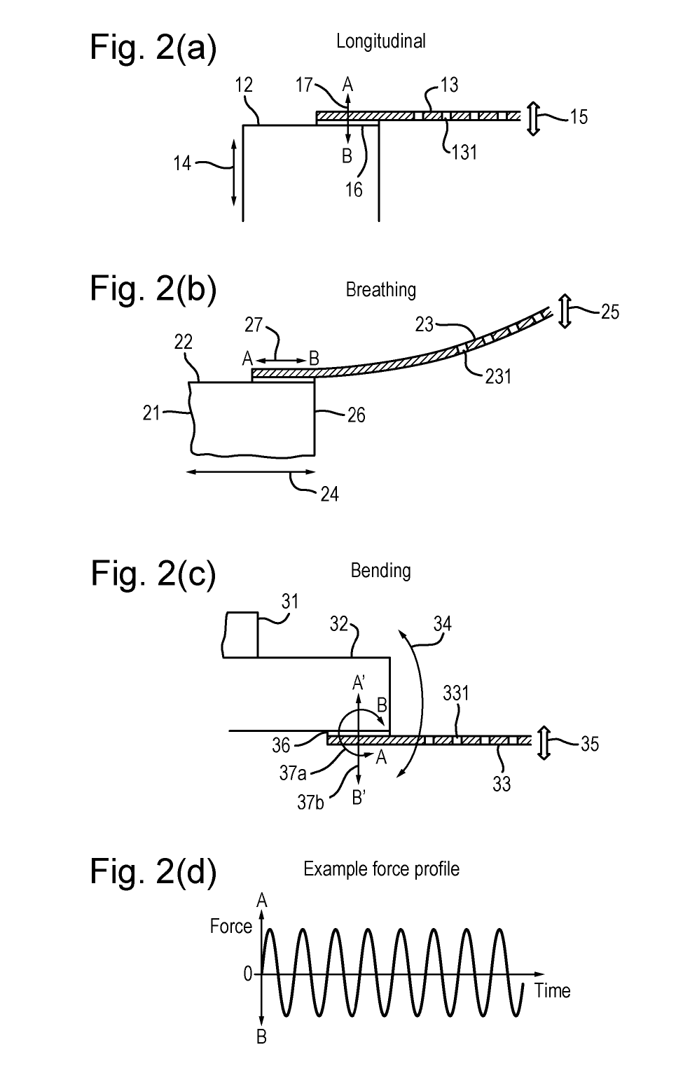

FIGS. 2(a)-2(d) are a detail view of the actuator to membrane interface showing the forces that need to be transmitted.

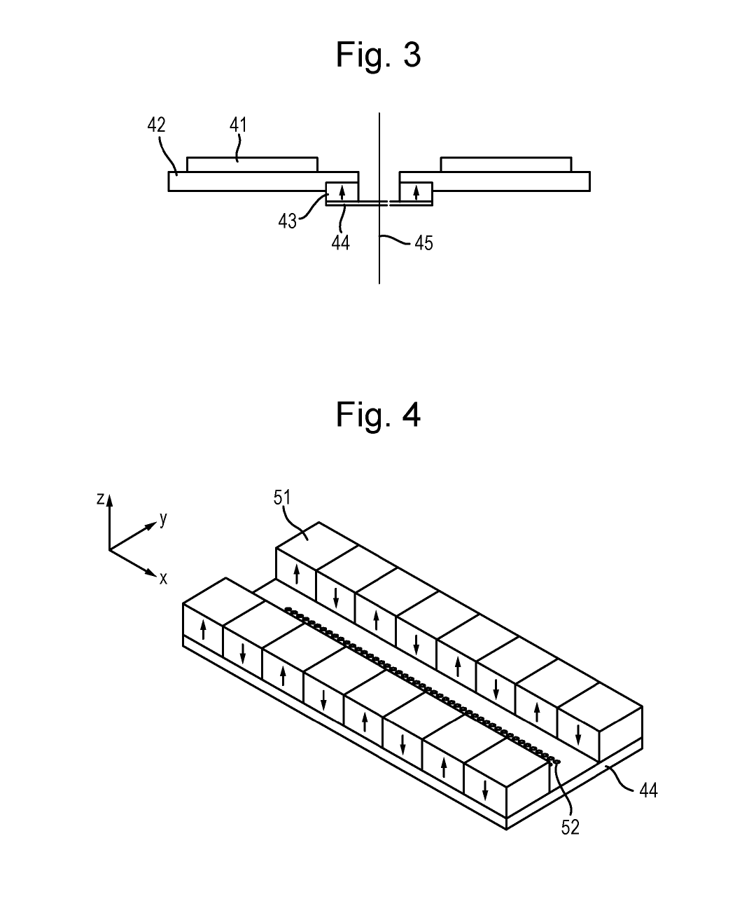

FIG. 3 shows a cross-sectional view of magnetic attachment of a perforate membrane to a bending mode actuator.

FIG. 4 shows the parts related to the magnetic attachment for a linear actuator.

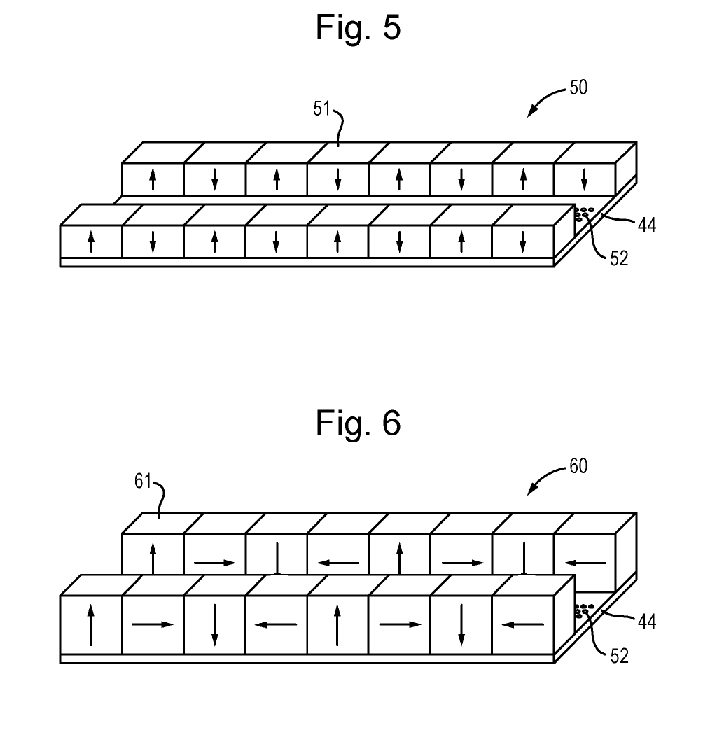

FIG. 5 shows details of the magnetic attachment for an embodiment with alternating z-axis magnetisation.

FIG. 6 shows details of the magnetic attachment for an embodiment with rotating Halbach array of magnets.

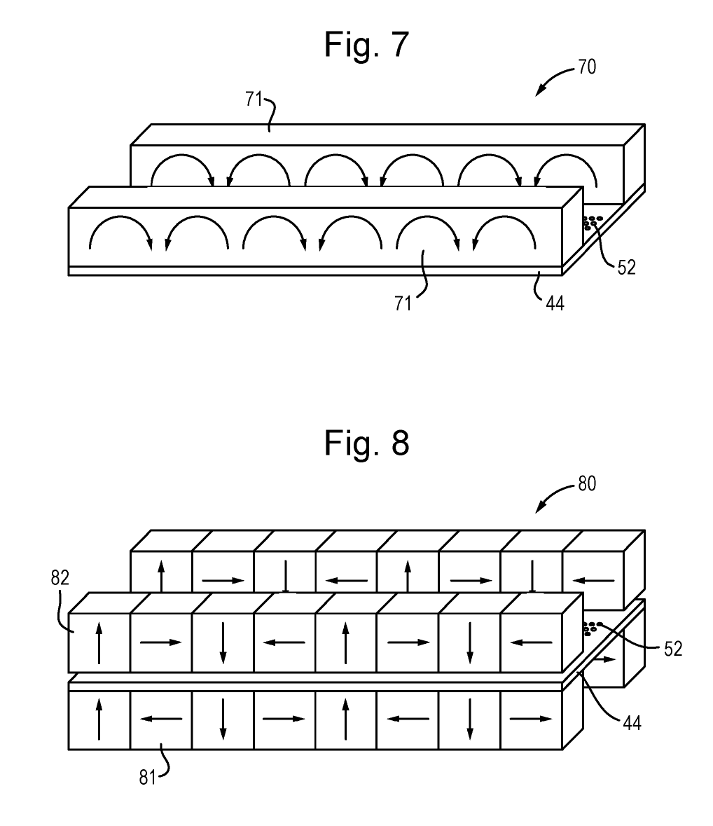

FIG. 7 shows details of the magnetic attachment for an embodiment with an isotropic magnetic material, which is magnetised to provide single-sided magnetic force.

FIG. 8 shows details of the magnetic attachment for an embodiment with an array of magnets attached to both the actuator and the separable element.

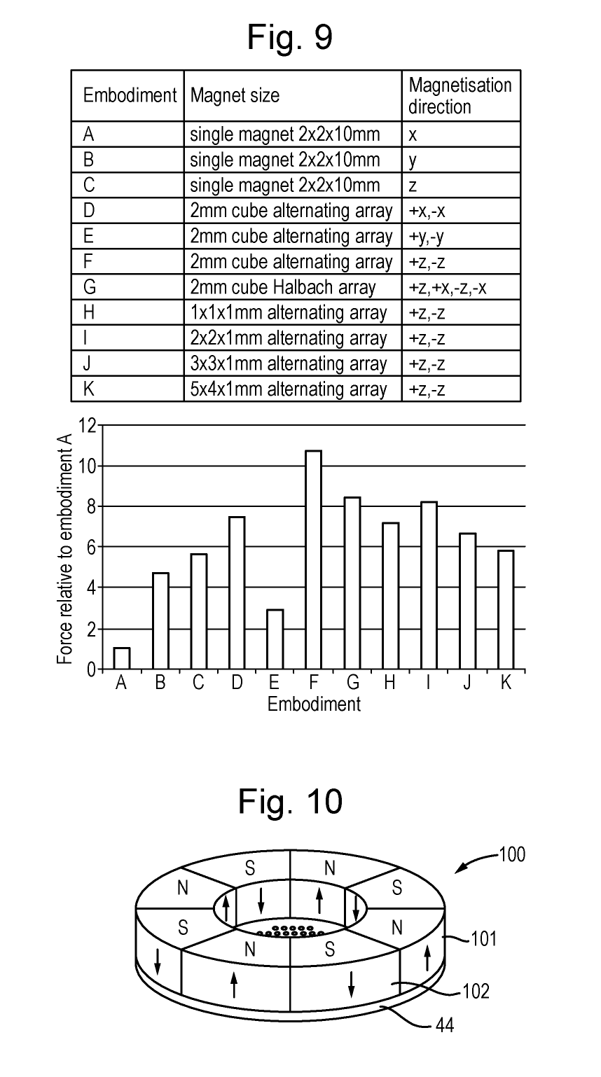

FIG. 9 shows a comparison of the attachment forces achieved from different magnetisation patterns and sizes of magnets.

FIG. 10 shows the parts related to the magnetic attachment for a circular actuator.

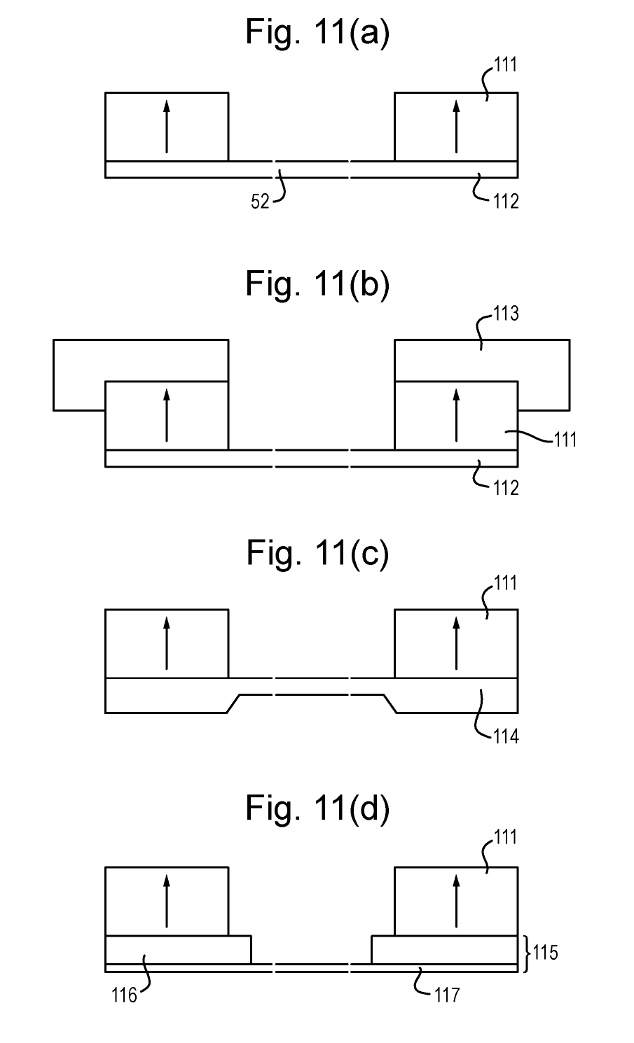

FIGS. 11(a)-11(d) show different perforate membrane structures that can be used in conjunction with the magnetic attachment methods.

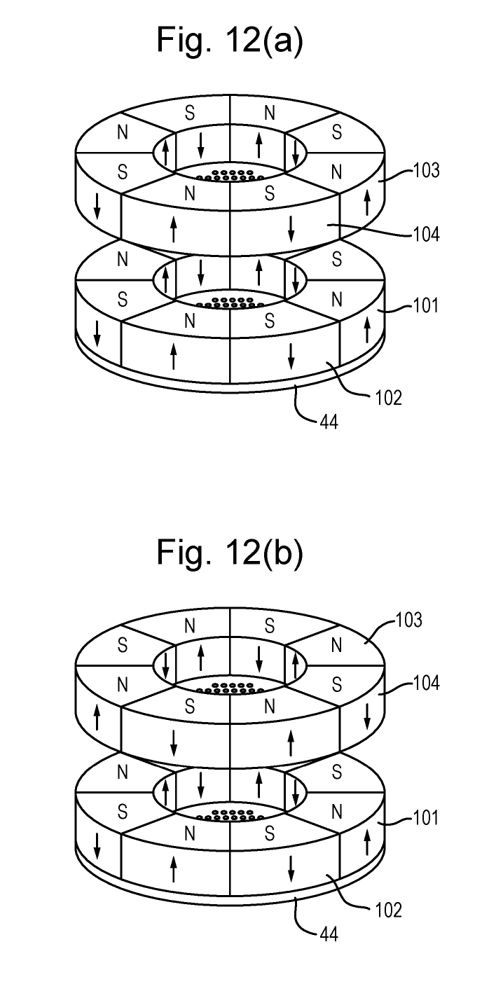

FIGS. 12(a)-12(b) show a method of switching the magnitude of the magnetic attachment force using an additional magnet array.

FIG. 1(a) shows an axi-symmetric droplet production apparatus known in the art of the longitudinal type (1). The actuator consists of an active component (11) bonded to a deforming passive component (12) designed such that at resonance the passive component amplifies the strain of the active component. A perforate membrane (13) is bonded to the actuator and the device has an overall axis of symmetry (10). Expansion and contraction of the actuator (14) leads to amplified motion (15) of the perforate membrane in a generally parallel direction. The membrane itself may all vibrate in phase, have one wavelength of motion across its radius (i.e. the central region may be out of phase with the periphery), or more than one wavelength of motion, depending on the design. FIG. 2(a) shows the detail of the actuator to membrane interface for this apparatus. The membrane is permanently attached to the actuator through a means such as adhesive bonding, laser welding, brazing, soldering or similar (16). This attachment mechanism must transmit a time varying force (17) across the interface with the force primarily normal to the bonding surface in directions A and B. Such a force, be way of an example, is sketched in FIG. 2(d). When the force is in direction A the bond (16) is in compression and when the force is in direction B the bond is in tension.

FIG. 1(b) shows another axi-symmetric droplet production apparatus but of the breathing type. Again the actuator consists of an active (21) and passive (22) component but in this instance planar actuator motion (24) leads to vibration of the membrane (23) in a direction normal to the actuator motion (25). The bond interface is shown in FIG. 2(b). For this type of actuator the bond (26) must primarily support the transmission of a shearing force (27) in a time varying radially inwards and then radially outwards direction.

A third type of device to which this invention is applicable is shown in FIG. 1(c). This device uses a unimorph actuator comprising an active (31) and a deforming passive (32) layer that operates in bending (34). This bending motion is connected to the membrane (33) and drives the membrane to vibrate in a direction (35) normal to the unimorph neutral plane. The bond detail is shown in FIG. 2(c) and in this case the bond (36) must transmit a time varying torque (37a) and normal force (37b) from the actuator to the membrane. The relative intensities and phases of these two bulk forces will be design dependant but the result is that the bond must support radially and time varying shear, compression and tension across its surface. This bending mode actuator can be configured in an axi-symmetric geometry, wherein the dot-dash line (30) shows the axis of symmetry, or in linear format, where the dot-dash line (30) is the centre-line of an actuator that extends out of the page.

An example of the use of magnetic attachment in an actuator is shown in FIG. 3. This device combines a bending mode actuator with a separable perforate membrane (44). The actuator typically comprises of a piezoelectric layer (41) bonded to a substrate (42) which is typically made of steel. The substrate could be a hard magnet, in which case separate magnetic elements may not be required. However, it is easier to manufacture the device with a substrate which is bonded to an array of magnets (43). The magnets provide an attractive force to hold a perforate membrane (44) in place. The perforate membrane (44) is typically a ferromagnetic material, so that an attractive force is provided. In a preferred embodiment, this material is a magnetic stainless steel, as high attachment forces are provided by materials with high saturation inductions. This bending mode actuator can be configured in an axi-symmetric geometry, wherein the dot-dash line (45) shows the axis of symmetry, or in linear format, where the dot-dash line (45) is the centre-line of an actuator that extends out of the page. In order to further increase the attachment force, the substrate (42) can be made of a magnetic grade of steel.

FIGS. 4 and 5 shows details of the magnetic attachment for an embodiment of a linear actuator which uses alternating z-axis magnetisation to provide attachment force to a soft magnetic membrane 44 containing perforations 52. This embodiment has the advantage that it can be constructed easily from magnets 51 which are rectangular cuboid in shape, but need not be regular cubes. Alternative shapes for the magnets 51 could be used depending on the shape and position of the membrane with the apparatus. This provides additional design freedom for the actuator design. It also allows construction with a single magnet part, such as a sintered NdFeB magnet. Sintered NdFeB magnets provide the highest available force, but they are not available in high aspect ratios and they have dimensional tolerances that can be limiting for other constructions.

FIG. 6 shows details of the magnetic attachment for an embodiment of a linear actuator 60 which uses a rotating array of magnets 61 in a Halbach array configuration. This has the advantage that it provides a very high attachment force, particularly for small magnets and has low leakage of magnetic flux out the rear side of the magnet array. Adjacent magnets are arranged with polarities 90° apart. A repeating pattern of groups of 4 magnets results from such an offset of polarities.

FIG. 7 shows details of the magnetic attachment for an embodiment of a linear actuator 70 which uses a single magnet 71 on each side of one surface of the perforate membrane 44, wherein the magnets are magnetised in a multi-pole configuration. In this embodiment, the magnetisation pattern is similar to that used in the Halbach array. This has the advantage of reducing the part count of the actuator. However, it has the disadvantage of restricting the range of magnet materials that can practically be used. The magnetisation pattern shown is limited to materials with isotropic magnetisation, but an alternating magnetisation pattern (similar to that shown in FIG. 5) could be use with anisotropic materials such as sintered rare earth magnets.

FIG. 8 shows details of the magnetic attachment for an embodiment of a linear actuator 80 which uses magnets 82 attached to the actuator and magnets 81 attached to the perforate membrane. The sets of magnets are aligned such that closed loops of flux are formed and hence a high attachment force is achieved. The disadvantages of this embodiment are a higher mass and a higher cost of the separable element.

FIG. 9 shows a comparison of the forces achieved by some different magnetisation arrangements. In this example, 2 mm sizes magnets with alternating z-axis magnetisation were found to provide the best trade-off between attachment force, actuator mass and manufacturability. The comparison applies to magnetic steel membranes with thickness of between 0.1 mm to 0.25 mm thickness, and different optimum conditions can be expected for different membrane thicknesses and materials. For example, 0.05 mm thickness membranes may be best suited to a smaller magnet size (around 1 mm), due to scaling laws.

FIG. 10 shows an actuator 100 using magnets 101,102 of alternating polarity to create a high attachment force in a circular format. This is then combined with an axi-symmetric actuator to produce a circular actuator with a magnetically separable membrane 44. Note that this is similar to the attachment method shown in FIG. 5, wrapped into a circle. In a similar manner, any of the embodiments described herein can also be applied to circular actuators.

FIG. 11 shows several variants of the magnetic materials that can be located in proximity to the magnet array, in particular variants to the membrane construction. FIG. 11(a) show the simplest construction, when the magnets 111 apply a force directly to a membrane 112 made of soft magnetic material. Laser-drilled nozzles 51 in a stainless steel membrane can provide a high attachment force. Electroformed nickel has a lower saturation magnetisation, and hence a lower attachment force, but can provide high quality nozzles, so can operate with lower applied forces in some applications. FIG. 11(b) shows an arrangement where a magnetically permeable element 113 of the actuator (e.g. the magnetic steel substrate) is used to provide an easy magnetic flux return path and increase the overall attachment force by around 15%. It can also make assembly of the actuator easier, as the magnets 111 are more inclined to stay in place during adhesive assembly to the actuator. FIG. 11(c) shows a tapered membrane 114 construction. Increasing the thickness of the membrane near the magnets 111 provides a higher attachment force, at the expense of a higher mass. This also allows the membrane stiffness and hence vibrational modes to be tailored to match the actuator design. This membrane construction can be produced by subtractive processes, such as electrochemical etching or laser machining, or by additive processes such as adhesive bonding, welding or diffusion bonding. FIG. 11(d) shows a laminated membrane 115, where one element 116 is selected for its magnetic properties (e.g. a 0.2 mm steel layer), whereas the perforated element 117 is selected for its ability to perform droplet generation when vibrated (e.g. a 0.05 mm polyimide layer). The layers are laminated together, for example by adhesive or thermal bonding processes.

Attachment and removal of the perforate membrane without damage can be quite difficult due to the high attachment forces involved. Additional magnets, which can be rotated or translated to align parallel to or anti-parallel to the attachment magnets can be used to increase or cancel the force from the attachment magnets. FIG. 12 shows a method for modulating the strength of the attachment force in the circular format. The attachment magnets (101,102) of alternating polarity are accompanied by switching magnets (103, 104). In FIG. 12(a), the ring of switching magnets is configured to increase the attachment force. In FIG. 12(b) the ring of switching magnets has been rotated to reduce the attachment force. In an alternative arrangement, the attachment magnets and/or the switching magnets could be turned on or off, by a switch or a switching means, to increase/reduce the attachment force.

1. A liquid droplet production apparatus comprising:
a perforate membrane;
a means for supplying liquid to one side of the membrane;
an actuator for vibrating a membrane, so that the vibration causes liquid droplets to be ejected from the other side of the membrane;
in which a magnetic force is used to connect the actuator to the membrane so that the vibration can be transmitted,
wherein the magnetic force is generated by one or more arrays of magnets, each array containing either a plurality of magnets or at least one magnet having a multiple pole configuration.

2. An apparatus according to claim 1, wherein a plurality of arrays is provided.

3. An apparatus according to claim 2, wherein two arrays are provided on opposing sides of a perforate portion of the membrane.

4. An apparatus according to claim 1, wherein opposing arrays of magnets are aligned such that directly opposing individual magnets have the same plurality alignment.

5. An apparatus according to claim 1, wherein a single array is provided.

6. An apparatus according to claim 5, wherein the single array is arranged in a circular configuration surrounding perforations in the membrane.

7. An apparatus according to claim 1, wherein adjacent magnets in an array of magnets have opposing polarity.

8. An apparatus according to claim 1, wherein adjacent magnets in an array of magnets have a polarity which is offset by 90°.

9. An apparatus according to claim 1, wherein the magnets in an array of magnets are arranged in a Halbach array.

10. An apparatus according to claim 1, wherein the membrane is provided with a thinner section in which the perforations are provided and a thicker section for attachment to the actuator.

11. An apparatus according to claim 10, wherein the transition from the thinner section to the thicker section is a step change.

12. An apparatus according to claim 10, wherein the transition from the thinner section to the thicker section is gradual.

13. An apparatus according to claim 10, wherein the transition from the thinner section to the thicker section is by way of a chamfer, a tapered section, or a curved section.

14. An apparatus according to claim 10, wherein the transition from the thinner section to the thicker section is at a constant angle.

15. An apparatus according to claim 1, wherein the actuator may include one or more magnets to which the magnets or poles of the one or more arrays of magnets are aligned.

16. An apparatus according to claim 1, further comprising switch means for switching one or more of the magnets off or for altering the polarity of one or more of the magnets may be provided.

17. An apparatus according to claim 15, wherein the magnets of the one or more arrays or those in the actuator are movable relative to the other of the magnets of the one or more arrays or those in the actuator.
